(19) United States
(12) Patent Application Publication
(10) Pub. No.: US 2023/0045067 A1
(43) Pub. Date: Feb. 9, 2023

(54) MULTILAYER STRUCTURE FOR TRANSPORTING OR STORING HYDROGEN

(71) Applicant: ARKEMA FRANCE, Colombes (FR)

(72) Inventors: Nicolas DUFAURE, Serquigny (FR); Patrick DANG, Serquigny (FR); Antoine GOUPIL, Seoul (KR)

(73) Assignee: ARKEMA FRANCE, Colombes (FR)

(21) Appl. No.: 17/758,738

(22) PCT Filed: Jan. 26, 2021
(86) PCT No.: PCT/FR2021/050140

§ 371 Date: Jul. 13, 2022

(30) Foreign Application Priority Data
Jan. 28, 2020 (FR) FR2000817

(51) Int. Cl. F17C 1/16; B32B 1/02; B32B 5/02; B32B 27/34; B32B 27/12; B32B 27/20; B32B 27/22; B32B 27/08

(52) U.S. Cl. CPC F17C 1/16; B32B 1/02; B32B 5/02; B32B 27/34; B32B 27/12; B32B 27/20; B32B 27/22; B32B 27/08; F17C 2221/012; F17C 2203/0675; F17C 2203/0663; F17C 2209/219; F17C 2203/0621; F17C 2203/0619; F17C 2203/0624; F17C 2203/0604; F17C 2270/0184; F17C 2270/0173; F17C 2209/2154; F17C 2270/0171; F17C 2270/0178; B32B 2439/40; B32B 2307/558; B32B 2260/021; B32B 2260/046; B32B 2262/101; B32B 2262/106; B32B 2262/10; B32B 2307/412; B32B 2262/14; B29C 70/32

(57) ABSTRACT

A multilayer structure for storing hydrogen, including, from the inside, at least one sealing layer and at least one composite reinforcement layer, an innermost composite reinforcement layer being welded to an outermost adjacent sealing layer, the sealing layers being a composition predominantly of: at least one semi-crystalline polyamide thermoplastic polymer P1i, i=1 to n, n being the number of sealing layers, excluding an amide polyether block (PEBA), up to 50% by weight of impact modifier relative to the total weight of the composition, up to 1.5% by weight of plasticizer relative to the total weight of the composition, and at least one of the composite reinforcement layers of a fibrous material in the form of continuous fibers, which is impregnated with a composition predominantly of at least one semi-crystalline polyamide polymer P2j, j=1 to m, m being the number of reinforcement layers.

### TECHNICAL FIELD

The present patent application relates to multilayer composite structures for transporting, distributing, or storing hydrogen, in particular for distributing or storing hydrogen, and the method for producing same.

### PRIOR ART

Hydrogen tanks are currently attracting a lot of attention from numerous manufacturers, especially in the automotive sector. One of the goals sought is to propose increasingly fewer polluting vehicles. Thus, electric or hybrid vehicles comprising a battery aim to progressively replace combustion engine vehicles such as either gas or diesel vehicles. It has turned out that the battery is a relatively complex vehicle component. Depending on the positioning of the battery in the vehicle, it may be necessary to protect it from impact and from the outside environment, which can have extreme temperatures and variable humidity. It is also necessary to avoid any risk of flames.

Additionally, it is important that the operating temperature thereof not exceed 55° C. in order to not break down the cells of the battery and to preserve the life thereof. Conversely, for example in winter, it may be necessary to increase the battery temperature so as to optimize operation thereof.

Moreover, electric vehicles still suffer today from several problems, namely battery range, the use in these batteries of rare earth metals, the resources for which are not infinite, much longer recharging times than the length of time taken to fill a tank, as well as a problem of electricity production in various countries in order to be able to recharge the batteries.

Hydrogen is therefore an alternative to the electric battery, since hydrogen can be converted into electricity by means of a fuel cell and thus power electric vehicles.

Hydrogen tanks usually consist of a metallic liner (or sealing layer) that must prevent hydrogen from permeating out. One of the types of tank envisaged, referred to as Type IV, is based on a thermoplastic liner around which a composite is wound.

Their basic principle is to separate the two essential functions of sealing and mechanical strength and manage them independently of each other. In this type of tank, the liner (or sealing sheath) made of thermoplastic resin is combined with a reinforcement structure consisting of fibers (glass, aramid, carbon) wrapped in a thermoplastic or thermosetting matrix, also known as a reinforcement sheath or layer, which makes it possible to operate at much higher pressures while reducing weight and avoiding risks of explosive rupture in the event of severe external attacks.

Liners must have certain fundamental characteristics:
The possibility to be transformed by extrusion blow molding, rotational molding, injection molding or extrusion
Low permeability to hydrogen, indeed, the permeability of the liner is a key factor in limiting hydrogen losses from the tank;
Good mechanical properties (fatigue) at low temperatures (−40 to −70° C.);
Thermal resistance at 120° C.

Indeed, it is necessary to increase the filling speed of the hydrogen tank, which should be roughly equivalent to that of a fuel tank for an internal combustion engine (about 3 to 5 minutes), but this increase in speed causes more significant heating of the tank, which then reaches a temperature of about 100° C.

The first generation of type IV tanks used a liner based on high-density polyethylene (HDPE).

However, HDPE has the disadvantage of having too low a melting point and high permeability to hydrogen, which represents a problem with new requirements in terms of thermal resistance and does not make it possible to increase the filling speed of the tank.

Liners based on polyamide PA6 have been in development for a number of years.

Nonetheless, PA6 has the disadvantage of having a low resistance to cold.

WO18155491 describes a hydrogen transport component having a three-layer structure, the inner layer of which is a composition consisting of PA11, from 15 to 50% of an impact modifier and from 1 to 3% of plasticizer, or devoid of plasticizer, which has hydrogen barrier properties, good flexibility and durability at low temperature. However, this structure is suitable for pipes for transporting hydrogen but not for the storage of hydrogen.

Thus, there is still a need to optimize, on the one hand, the matrix of the composite so as to optimize its mechanical strength at high temperature and, on the other hand, the material composing the sealing sheath, so as to optimize its operating temperature. Thus, the optional modification of the composition of the material composing the sealing liner which will be carried out must not result in a significant increase in the manufacturing temperature (extrusion blow molding, injection molding, rotational molding, etc.) of this liner compared to what is practiced today.

These problems are solved by providing a multilayer structure of the present invention intended for transporting, distributing or storing hydrogen

Throughout this description, the terms “liner” and “sealing sheath” have the same meaning.

The present invention therefore relates to a multilayer structure intended for transporting, distributing and storing hydrogen, in particular for storing hydrogen, comprising, from the inside to the outside, a sealing layer (1) and at least one composite reinforcement layer (2),
said innermost composite reinforcing layer (2) being welded to said outermost adjacent sealing layer (1),
said sealing layers (1) consisting of a composition mainly comprising: at least one semi-crystalline polyamide thermoplastic polymer P1i, i=1 to n, where n is the number of sealing layers, excluding a polyether block amide (PEBA),
up to 50% by weight of impact modifier, especially up to less than 15% by weight of impact modifier, in particular up to 12% by weight of impact modifier relative to the total weight of the composition,
up to 1.5% by weight of plasticizer relative to the total weight of the composition, said at least one polyamide thermoplastic polymer in each sealing layer may be the same or different,
and at least one of said composite reinforcement layers consisting of a fibrous material in the form of continuous fibers, which is impregnated with a composition predominantly comprising at least one semi-crystalline polyamide polymer P2j, j=1 to m, m being the number of reinforcement layers,
the number of carbon atoms per amide function of the polyamide of said outermost adjacent sealing layer (1) differing from that of the polyamide of said innermost reinforcing layer (2) by at most 20%.

The Inventors have therefore unexpectedly found that the use of a semi-crystalline polyamide thermoplastic polymer P1i, in particular short-chain or long-chain, comprising a limited proportion of impact modifier and plasticizer, for the sealing layer, with a semi-crystalline thermoplastic polymer P2j for the matrix of the composite, said composite being welded to the sealing layer, and the two polymers P1i and P2j of the sealing layer adjacent to the composite reinforcement layer differing in their number of carbon atoms per amide function of at most 20%, making it possible to obtain a structure suitable for the transport, distribution or storage of hydrogen, and in particular for the storage of hydrogen as well as an increase in the maximum temperature of use that can reach up to 120° C., thus making it possible to increase the speed of filling of the tanks.

By “multilayer structure”, a tank comprising or consisting of several layers is meant, namely several sealing layers and several reinforcing layers, or one sealing layer and several reinforcing layers, or several sealing layers and a reinforcing layer or a sealing layer and a reinforcing layer.

The multilayer structure is therefore understood to exclude a pipe or a tube.

Polyether block amides (PEBAs) are copolymers with amide units (Ba1) and polyether units (Ba2), said amide unit (Ba1) corresponding to an aliphatic repeating unit chosen from a unit obtained from at least one amino acid or a unit obtained from at least one lactam, or a unit X.Y obtained from the polycondensation:
of at least one diamine, said diamine preferentially being chosen from a linear or branched aliphatic diamine or a mixture thereof, and
of at least one carboxylic diacid, said diacid preferentially being chosen from: a linear or branched aliphatic diacid, or a mixture thereof,
said diamine and said diacid comprising 4 to 36 carbon atoms, advantageously 6 to 18 carbon atoms;
said polyether units (Ba2) being derived in particular from at least one polyalkylene ether polyol, in particular a polyalkylene ether diol. In one embodiment, said constituent composition of said sealing layer is devoid of nucleating agent.

Nucleating agents are known to those skilled in the art and the term refers to a substance which, when incorporated into a polymer, forms nuclei for the growth of crystals in the molten polymer.

They may be selected for example from microtalc, carbon black, silica, titanium dioxide and nanoclays.

In another embodiment, said constituent composition of said sealing layer is devoid of nucleating agent and plasticizer.

In one embodiment, said structure is also devoid of an outermost layer and adjacent to the outermost layer of composite reinforcement made of polyamide polymer.

In one embodiment, said multilayer structure only consists of two layers, a sealing layer and a reinforcement layer.

The sealing layer or layers are the innermost layers compared to the composite reinforcing layers, which are the outermost layers.

The tank may be a tank for the mobile storage of hydrogen, that is on a truck for transporting hydrogen, on a car for transporting hydrogen and for supplying a fuel cell with hydrogen, for example, on a train for supplying hydrogen or on a drone for supplying hydrogen, but it can also be a tank for the stationary storage of hydrogen in a station for distributing hydrogen to vehicles.

Advantageously, the sealing layer (1) is leaktight to hydrogen at 23° C., that is the permeability to hydrogen at 23° C. is less than 500 cc—mm/m2·24 h·atm at 23° C. under 0% relative humidity (RH).

In one embodiment, said sealing layer or layers consist of a composition mainly comprising:
at least one polyamide thermoplastic polymer P1i, i=1 to n, n being the number of sealing layers, semi-crystalline, excluding a polyether block amide (PEBA), and excluding PA11.

The composite reinforcement layer(s) is (are) wound around the sealing layer by means of ribbons (or tapes or rovings) of fibers impregnated with polymer, which are deposited for example by filament winding.

When several layers are present, the polymers may be different.

When the polymers of the reinforcement layers are identical, several layers may be present, but advantageously a single reinforcement layer is present which then has at least one full winding around the sealing layer.

Even if a single layer is present, several successive complete windings around the sealing layer can be made and constitute said single layer.

This entirely automatic process which is well known to those skilled in the art makes it possible, layer by layer, to select the winding angles which will afford the final structure its ability to withstand internal pressure loading.

When several sealing layers are present, only the innermost of the sealing layers is in direct contact with the hydrogen.

When only a sealing layer and a composite reinforcing layer are present, thus leading to a two-layer multilayer structure, then those two layers are welded to each other, i.e. they adhere to each other, in direct contact with each other.

When several sealing layers and/or several composite reinforcing layers are present, then the outermost layer of said sealing layers, and thus the one opposite the layer in contact with the hydrogen, is welded to the innermost layer of said composite reinforcing layers, and thus adhered to each other, in direct contact with each other.

The other composite reinforcing layers also adhere to each other.

The other sealing layers also adhere to each other.

Advantageously, only one sealing layer and one reinforcement layer are present and are not welded to each other.

### Regarding the Sealing Layer(s) and the Thermoplastic Polymer P1i

One or more sealing layers may be present.

Each of said layers consists of a composition predominantly comprising a at least one thermoplastic polymer P1i, i corresponding to the number of layers present. i is from 1 to 10, in particular from 1 to 5, especially from 1 to 3, preferentially i=1.

The term “predominantly”means that said at least one polymer is present in excess of 50% by weight relative to the total weight of the composition.

Advantageously, said at least one predominant polymer is present at more than 60% by weight, especially at more than 70% by weight, particularly at more than 80% by weight, more particularly greater than or equal to 90% by weight, relative to the total weight of the composition.

Said composition may also comprise up to 50% by weight relative to the total weight of the composition of impact modifiers and/or a plasticizer and/or additives.

The additives may be selected from another polymer, an antioxidant, a heat stabilizer, a UV absorber, a light stabilizer, a lubricant, an inorganic filler, a flame retardant, a dye, carbon black and carbonaceous nanofillers, in particular, the additives are selected from an antioxidant, a heat stabilizer, a UV absorber, a light stabilizer, a lubricant, an inorganic filler, a flame retardant, a dye, carbon black and carbonaceous nanofillers.

In one embodiment the nucleating agents are excluded from the additives.

In another embodiment, the nucleating agents are excluded from the additives and in this case, the composition is also devoid of plasticizer.

Said other polymer may be another semi-crystalline thermoplastic polymer or a different polymer and especially an EVOH (Ethylene vinyl alcohol).

Advantageously, said composition predominantly comprises said thermoplastic polymer P1i, from 0 to 50% by weight of impact modifier, especially from 0 to less than 15% of impact modifier, in particular from 0 to 12% of impact modifier, from 0 to 1.5% of plasticizer and from 0 to 5% by weight of additives, the sum of the constituents of the composition being equal to 100%.

Advantageously, said composition predominantly consists of said thermoplastic polymer P1i, from 0 to 50% by weight of impact modifier, especially from 0 to less than 15% of impact modifier, in particular from 0 to 12% of impact modifier, from 0 to 1.5% of plasticizer and from 0 to 5% by weight of additives, the sum of the constituents of the composition being equal to 100%.

Advantageously, said composition predominantly comprises said thermoplastic polymer P1i, from 0 to 50% by weight of impact modifier, especially from 0 to less than 15% of impact modifier, in particular from 0 to 12% of impact modifier, from 0 to 1.5% of plasticizer and from 0 to 5% by weight of additives, the sum of the constituents of the composition being equal to 100%.

Advantageously, said composition predominantly consists of said thermoplastic polymer P1i, from 0 to 50% by weight of impact modifier, especially from 0 to less than 15% of impact modifier, in particular from 0 to 12% of impact modifier, from 0 to 1.5% of plasticizer and from 0 to 5% by weight of additives, the sum of the constituents of the composition being equal to 100%.

Advantageously, said composition predominantly comprises said thermoplastic polymer P1i, from 0 to 50% by weight of impact modifier, especially from 0 to less than 15% of impact modifier, in particular from 0 to 12% of impact modifier, from 0 to 5% of plasticizer and from 0 to 5% by weight of additives, the sum of the constituents of the composition being equal to 100%.

Advantageously, said composition predominantly consists of said thermoplastic polymer P1i, from 0 to 50% by weight of impact modifier, especially from 0 to less than 15% of impact modifier, in particular from 0 to 12% of impact modifier, from 0 to 5% of plasticizer and from 0 to 5% by weight of additives, the sum of the constituents of the composition being equal to 100%.

Said at least one predominant polymer in each layer may be the same or different.

In one embodiment, a single predominant polymer is present in at least the sealing layer that adheres to the composite reinforcing layer.

In one embodiment, said composition comprises an impact modifier of 0.1 to 50% by weight, especially from 0.1 to less than 15% by weight, in particular from 0.1 to 12% by weight of impact modifier relative to the total weight of the composition.

In one embodiment, said composition is devoid of plasticizer.

In another embodiment, said composition comprises an impact modifier of 0.1 to 50% by weight, especially of 0.1 to less than 15% by weight, in particular of 0.1 to 12% by weight of impact modifier, and said composition is devoid of plasticizer relative to the total weight of the composition.

In yet another embodiment, said composition comprises an impact modifier of 0.1 to 50% by weight, especially of 0.1 to less than 15% by weight, and of 0.1 to 1.5% by weight of plasticizer relative to the total weight of the composition.

### Semi-Crystalline Polyamide Thermoplastic Polymer P1i

“Thermoplastic” or “semi-crystalline polyamide thermoplastic polymer”refers to a material that is generally solid at ambient temperature, and which softens during a temperature increase, in particular after passing its glass transition temperature (Tg), and may exhibit precise melting upon passing what is referred to as its melting point (Tm), and which becomes solid again when the temperature decreases below its crystallization temperature.

The Tg, the Tc and the Tm are determined by differential scanning calorimetry (DSC) according to standards 11357-2:2013 and 11357-3:2013, respectively.

The number-average molecular weight Mn of said semi-crystalline polyamide thermoplastic polymer is preferably in a range extending from 10,000 to 85,000, especially from 10,000 to 60,000, preferentially from 10,000 to 50,000, even more preferentially from 12,000 to 50,000. These Mn values may correspond to inherent viscosities greater than or equal to 0.8, as determined in m-cresol according to standard ISO 307:2007 but by changing the solvent (use of m-cresol instead of sulfuric acid and the temperature being 20° C.).

The nomenclature used to define the polyamides is described in ISO standard 1874-1:2011 “Plastiques—Matériaux polyamides (PA) pour moulage et extrusion—Partie 1: Désignation”, especially on page 3 (Tables 1 and 2) and is well known to the person skilled in the art.

The polyamide may be a homopolyamide or a co-polyamide or a mixture thereof.

In one embodiment, said thermoplastic polymer is a short-chain semi-crystalline aliphatic polyamide, i.e. a polyamide having an average number of carbon atoms per nitrogen atom of up to 9, or a long-chain aliphatic polyamide .e., a polyamide having an average number of carbon atoms per nitrogen atom greater than 9, preferably greater than 10.

In particular, the short-chain aliphatic polyamide is selected from: PA6, a PA610, a PA612 eta PA6/polyolefin mixture

In particular, the long-chain aliphatic polyamide is selected from: polyamide 11 (PA11), polyamide 12 (PA12), polyamide 1010 (PA1010), polyamide 1012 (PA1012), polyamide 1212 (PA1012), or a mixture thereof or a copolyamide thereof, in particular PA11 and PA12.

In one embodiment, the long-chain aliphatic polyamide is selected from: polyamide 12 (PA12), polyamide 1010 (PA1010), polyamide 1012 (PA1012b), polyamide 1212 (PA1012), or a mixture thereof or a copolyamide thereof, in particular PA12.

In another embodiment, said semi-crystalline polyamide thermoplastic polymer is a semi-crystalline semi-aromatic polyamide, in particular a semi-crystalline semi-aromatic polyamide having an average number of carbon atoms per nitrogen atom greater than 8, preferably greater than 9 and a melting temperature between 240° C. to less than 280° C.

Advantageously, the semi-crystalline polyamides are semi-aromatic polyamide, especially a semi-aromatic polyamide of formula X/YAr, as described in EP1505099, particularly a semi-aromatic polyamide of formula A/XT wherein A is selected from a unit obtained from an amino acid, a unit obtained from a lactam and a unit corresponding to the formula (Ca diamine).(Cb diacid), with a representing the number of carbon atoms of the diamine and b representing the number of carbon atoms of the diacid, a and b each being between 4 and 36, advantageously between 9 and 18, the unit (Ca diamine) being selected from linear or branched aliphatic diamines, cycloaliphatic diamines and alkylaromatic diamines and the unit (Cb diacid) being selected from linear or branched aliphatic diacids, cycloaliphatic diacids and aromatic diacids;

X.T denotes a unit obtained from the polycondensation of a Cx diamine and terephthalic acid, with x representing the number of carbon atoms of the Cx diamine, x being between 5 and 36, advantageously between 9 and 18, especially a polyamide with formula N5T, A/6T, A/9T, A/10T, or A/11T, A being as defined above, in particular a polyamide chosen from among a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, PA BACT/10T/6T, a PA 11/BACT/6T, PA 11/MPMDT/6T, PA 11/MPMDT/10T, PA 11/BACT/10T, a PA 11/MXDT/10T, an 11/5T/10T.

In particular, the semi-aromatic semi-crystalline polyamide is chosen from polyamide 11/5T or 11/6T or 11/10T, the MXDT/10T, the MPMDT/10T and the BACT/10T.

T corresponds to terephthalic acid, MXD corresponds to m-xylylene diamine, MPMD corresponds to methylpentamethylene diamine and BAC corresponds to bis(aminomethyl)cyclohexane. Said semi-aromatic polyam ides defined above especially have a Tg of greater than or equal to 80° C.

Advantageously, each sealing layer consists of a composition comprising the same type of polyamide.

Said composition comprising said polymer P1i may be black in color and capable of absorbing radiation suitable for welding that is then carried out after winding the composite reinforcement layer around the sealing layer.

In the event that welding is necessary, there are various methods making it possible to weld elements made of polyamide thermoplastic polymer. Thus, contact or contactless heating blades, ultrasound, infrared, induction, vibrations, rotation of one element to be welded against the other or even laser welding may be used.

The welding of polyamide thermoplastic polymer elements, in particular by laser welding, may require that the two elements to be welded have different properties with respect to radiation, in particular laser radiation: one of the elements must be transparent to radiation, in particular laser radiation, and the other must absorb the radiation, in particular laser radiation. The radiation in particular laser radiation passes through the transparent part and then reaches the absorbing element, where it is converted into heat. This allows the contact area between the two elements to melt and thus the welding to take place.

In the case of carbon fibers, the preferred case is a melting of the interface at the time of removal.

In order to make them absorbent, it is known to add various additives, including for example carbon black, which gives the polymer a black color and allows it to absorb radiation suitable for welding.

In one embodiment, the welding is performed by a system selected from laser, infrared (IR) heating, LED heating, induction or microwave heating or high frequency (HF) heating.

In the case where the welding is carried out by laser welding, then the composition P1i comprises carbonaceous fillers.

In the case where the welding is carried out by induction, then the composition P1i comprises metallic particles.

Advantageously, the welding is performed by a laser system.

### Regarding the Impact Modifier

The impact modifier may be any impact modifier as long as it is a polymer having a modulus below that of the resin, having good adhesion to the matrix, so as to dissipate cracking energy.

The impact modifier advantageously consists of a polymer having a flexural modulus below 100 MPa measured according to standard ISO 178 and a Tg below 0° C. (measured according to standard 11357-2 at the inflection point of the DSC thermogram), in particular a polyolefin.

In one embodiment, PEBAs are excluded from the definition of impact modifiers.

The polyolefin of the impact modifier may be functionalized or non-functionalized or be a mixture of at least one functionalized polyolefin and/or least one non-functionalized polyolefin. To simplify, the polyolefin is denoted (B) and functionalized polyolefins (B1) and non-functionalized polyolefins (B2) are described below.

A non-functionalized polyolefin (B2) is classically a homopolymer or copolymer of alpha-olefins or diolefins, such as for example, ethylene, propylene, 1-butene, 1-octene, butadiene. By way of example, mention may be made of:
the homopolymers and copolymers of polyethylene, particularly LDPE, HDPE, LLDPE (linear low-density polyethylene), VLDPE (very low density polyethylene) and metallocene polyethylene.
homopolymers or copolymers of propylene.
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
copolymers of ethylene with at least one product chosen from the salts or esters of unsaturated carboxylic acids such as alkyl (meth)acrylate (for example methyl acrylate), or the vinyl esters of saturated carboxylic acids such as vinyl acetate (EVA), where the proportion of comonomer can reach 40% by weight.

The functionalized polyolefin (B1) may be a polymer of alpha-olefins having reactive units (functionalities); such reactive units are acid, anhydride, or epoxy functions. By way of example, mention may be made of the preceding polyolefins (B2) grafted or co- or ter-polymerized by unsaturated epoxides such as glycidyl (meth)acrylate, or by carboxylic acids or the corresponding salts or esters such as (meth)acrylic acid (which can be completely or partially neutralized by metals such as Zn, etc.) or even by carboxylic acid anhydrides such as maleic anhydride. A functionalized polyolefin is for example a PE/EPR mixture, the ratio by weight whereof can vary widely, for example between 40/60 and 90/10, said mixture being co-grafted with an anhydride, especially maleic anhydride, according to a graft rate for example of 0.01 to 5% by weight.

The functionalized polyolefin (B1) may be chosen from the following, maleic anhydride or glycidyl methacrylate grafted, (co)polymers wherein the graft rate is for example from 0.01 to 5% by weight:
of PE, of PP, of copolymers of ethylene with propylene, butene, hexene, or octene containing for example from 35 to 80% by weight of ethylene;
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
ethylene and vinyl acetate copolymers (EVA), containing up to 40% by weight of vinyl acetate;
ethylene and alkyl (meth)acrylate copolymers, containing up to 40% by weight of alkyl (meth)acrylate;
ethylene and vinyl acetate (EVA) and alkyl (meth)acrylate copolymers, containing up to 40% by weight of comonomers.

The functionalized polyolefin (B1) may also be selected from ethylene/propylene copolymers with predominantly maleic anhydride grafted propylene condensed with a mono-amine polyamide (or a polyamide oligomer) (products described in EP-A-0,342,066).

The functionalized polyolefin (B1) may also be a co- or terpolymer of at least the following units: (1) ethylene, (2) alkyl (meth)acrylate or vinyl ester of saturated carboxylic acid and (3) anhydride such as maleic anhydride or (meth)acrylic acid or epoxy such as glycidyl (meth)acrylate.

By way of example of functionalized polyolefins of the latter type, mention may be made of the following copolymers, where ethylene represents preferably at least 60% by weight and where the termonomer (the function) represents for example from 0.1 to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, (meth)acrylic acid can be salified with Zn or Li.

The term “alkyl (meth)acrylate” in (B1) or (B2) denotes C1 to C8 alkyl methacrylates and acrylates, and may be chosen from methyl acrylate, ethyl acrylate, n-butyl acrylate, isobutyl acrylate, 2-ethyl-hexyl acrylate, cyclohexyl acrylate, methyl methacrylate and ethyl methacrylate.

Moreover, the previously cited polyolefins (B1) may also be crosslinked by any appropriate method or agent (diepoxy, diacid, peroxide, etc.); the term functionalized polyolefin also comprises mixtures of the previously cited polyolefins with a difunctional reagent such as a diacid, dianhydride, diepoxy, etc. that can react with these or mixtures of at least two functionalized polyolefins that can react together.

The copolymers mentioned above, (B1) and (B2), may be copolymerized in a statistical or sequenced way and have a linear or branched structure.

The molecular weight, the index MFI, the density of these polyolefins may also vary widely, which the person skilled in the art will know. MFI, abbreviation for Melt Flow Index, is a measure of fluidity in the molten state.

It is measured according to standard ASTM 1238.

Advantageously the non-functionalized polyolefins (B2) are selected from homopolymers or copolymers of polypropylene and any ethylene homopolymer or ethylene copolymer and a higher alpha-olefin comonomer such as butene, hexene, octene or 4-methyl-1-pentene. Mention may be made for example of PPs, high-density PEs, medium-density PEs, linear low-density PEs, low-density PEs, very low-density PEs. These polyethylenes are known by the person skilled in the art as being produced according to a “free-radical” method, according to a “Ziegler” catalysis method, or, more recently, a “metallocene”catalysis.

Advantageously the functionalized polyolefins (B1) are chosen from any polymer comprising alpha-olefin units and units carrying polar reactive functions like epoxy, carboxylic acid or carboxylic acid anhydride functions. By way of examples of such polymers, mention may be made of terpolymers of ethylene, of alkyl acrylate and of maleic anhydride or of glycidyl methacrylate like Lotader® from the Applicant or polyolefins grafted by maleic anhydride like Orevac® from the Applicant and terpolymers of ethylene, alkyl acrylate and (meth)acrylic acid. Mention may also be made of homopolymers or copolymers of polypropylene grafted by a carboxylic acid anhydride then condensed with polyam ides or monoamine polyamide oligomers.

Advantageously, said composition constituting said sealing layer(s) is devoid of polyether block amide (PEBA). In this embodiment, PEBAs are therefore excluded from impact modifiers.

Advantageously, said transparent composition is devoid of core-shell particles or core-shell polymers.

Core-shell particle must be understood as a particle whose first layer forms the core and the second or all following layers form the respective shells.

The core-shell particle may be obtained by a method with several steps comprising at least two steps. Such a method is described for example in documents US2009/0149600 or EP0,722,961.

### Regarding the Plasticizer:

The plasticizer may be a plasticizer commonly used in compositions based on polyamide(s).

Advantageously, use is made of a plasticizer which has good thermal stability so that it does not form fumes during the steps of mixing the different polymers and transforming the composition obtained.

In particular, this plasticizer may be selected from:
benzenesulfonamide derivatives, such as n-butyl benzenesulfonamide (BBSA), the ortho and para isomers of ethyl toluenesulfonamide (ETSA), N-cyclohexyl toluenesulfonamide and N-(2-hydroxypropyl)benzenesulfonamide (HP-BSA), esters of hydroxybenzoic acids, such as 2-ethylhexyl para-hydroxybenzoate (EHPB) and 2-decylhexyl para-hydroxybenzoate (HDPB),
esters or ethers of tetrahydrofurfuryl alcohol, such as oligoethyleneoxytetrahydrofurfuryl alcohol, and
esters of citric acid or hydroxymalonic acid, such as oligoethyleneoxymalonate.

A preferred plasticizer is n-butyl benzenesulfonamide (BBSA).

Another, more particularly preferred plasticizer is N-(2-hydroxypropyl)benzenesulfonamide (HP-BSA). Indeed, the latter has the advantage of preventing the formation of deposits at the extrusion screw and/or die (“die drool”) during a step of transformation by extrusion.

Of course, it is possible to use a mixture of plasticizers.

### Regarding the Composite Reinforcement Layer and the Polymer P2j

The polymer P2j is a semi-crystalline polyamide thermoplastic polymer, said semi-crystalline polyamide thermoplastic polymer having the same definition as above.

One or more composite reinforcement layers may be present.

Each of the said layers consists of a fibrous material in the form of continuous fibers impregnated with a composition predominantly comprising at least one thermoplastic polymer P2j, j corresponding to the number of layers present.

j is comprised from 1 to 10, in particular from 1 to 5, especially from 1 to 3, preferentially j=1.

The term “predominantly”means that said at least one polymer is present at more than 50% by weight relative to the total weight of the composition and of the matrix of the composite.

Advantageously, said at least one predominant polymer is present at more than 60% by weight, especially at more than 70% by weight, particularly at more than 80% by weight, more particularly greater than or equal to 90% by weight, relative to the total weight of the composition.

Said composition may further comprise impact modifiers and/or additives.

The additives may be chosen from an antioxidant, a heat stabilizer, a UV absorber, a light stabilizer, a lubricant, an inorganic filler, a flame retardant agent, a plasticizer, and a dye.

In one embodiment, the additives exclude a nucleating agent.

Advantageously, said composition predominantly consists of said polyamide thermoplastic polymer P2j, from 0 to 15% by weight of impact modifier, in particular from 0 to 12% by weight of impact modifier, from 0 to 5% by weight of additives, the sum of the constituents of the composition being equal to 100% by weight.

Advantageously, said composition predominantly consists of said polyamide thermoplastic polymer P2j, from 0 to 15% by weight of impact modifier, in particular from 0 to 12% by weight of impact modifier, from 0 to 5% by weight of additives, the sum of the constituents of the composition being equal to 100% by weight.

Advantageously, said composition predominantly consists of said polyamide thermoplastic polymer P2j, from 0 to 15% by weight of impact modifier, in particular from 0 to 12% by weight of impact modifier, from 0 to 5% by weight of additives, the sum of the constituents of the composition being equal to 100% by weight.

Advantageously, said composition predominantly consists of said polyamide thermoplastic polymer P2j, from 0 to 15% by weight of impact modifier, in particular from 0 to 12% by weight of impact modifier, from 0 to 5% by weight of additives, the sum of the constituents of the composition being equal to 100% by weight.

Said at least one predominant polymer in each layer may be the same or different.

In one embodiment, each reinforcing layer comprises the same type of polyamide.

### Polymer P2j

### Polyamide Thermoplastic Polymer P2j

“Thermoplastic” or “semi-crystalline polyamide thermoplastic polymer” refers to a material that is generally solid at ambient temperature, and which softens during a temperature increase, in particular after passing its glass transition temperature (Tg), and may exhibit precise melting upon passing what is referred to as its melting point (Tm), and which becomes solid again when the temperature decreases below its crystallization temperature.

The Tg, Tc, and Tm are determined by differential scanning calorimetry (DSC) according to standard 11357-2:2013 and 11357-3:2013, respectively.

The number-average molecular weight Mn of said polyamide thermoplastic polymer P2j is preferably in a range extending from 10,000 to 40,000, preferably from 10,000 to 30,000. These Mn values may correspond to inherent viscosities greater than or equal to 0.8, as determined in m-cresol according to standard ISO 307:2007 but by changing the solvent (use of m-cresol instead of sulfuric acid and the temperature being 20° C.).

The nomenclature used to define the polyamides is described in ISO standard 1874-1:2011 “Plastiques—Matériaux polyamides (PA) pour moulage et extrusion—Partie 1: Désignation”, especially on page 3 (Tables 1 and 2) and is well known to the person skilled in the art.

The polyamide may be a homopolyamide or a co-polyamide or a mixture thereof.

In one embodiment, said thermoplastic polymer is a short-chain semi-crystalline aliphatic polyamide, i.e. a polyamide having an average number of carbon atoms per nitrogen atom of up to 9, or a long-chain aliphatic polyamide i.e., a polyamide having an average number of carbon atoms per nitrogen atom greater than 9, preferably greater than 10.

In particular, the short-chain aliphatic polyamide is selected from: PA6, a PA610, a PA612 et a PA6/polyolefin mixture

In particular, the long-chain aliphatic polyamide is selected from: polyamide 11 (PA11), polyamide 12 (PA12), polyamide 1010 (PA1010), polyamide 1012 (PA1012), polyamide 1212 (PA1012), or a mixture thereof or a copolyamide thereof, in particular PA11 and PA12.

In one embodiment, the long-chain aliphatic polyamide is selected from: polyamide 12 (PA12), polyamide 1010 (PA1010), polyamide 1012 (PA1012), polyamide 1212 (PA1012), or a mixture thereof or a copolyamide thereof, in particular PA12.

In another embodiment, said semi-crystalline polyamide thermoplastic polymer is a semi-crystalline semi-aromatic polyamide, in particular a semi-crystalline semi-aromatic polyamide having an average number of carbon atoms per nitrogen atom greater than 8 preferably greater than 9 and a melting temperature of between 240° C. to less than 280° C.

Advantageously, the semi-crystalline polyamides are semi-aromatic polyamide, especially a semi-aromatic polyamide of formula X/YAr, as described in EP1505099, particularly a semi-aromatic polyamide of formula A/XT wherein A is selected from a unit obtained from an amino acid, a unit obtained from a lactam and a unit corresponding to the formula (Ca diamine).(Cb diacid), with a representing the number of carbon atoms of the diamine and b representing the number of carbon atoms of the diacid, a and b each being between 4 and 36,advantageously between 9 and 18, the unit (Ca diamine) being selected from linear or branched aliphatic diamines, cycloaliphatic diamines and alkylaromatic diamines and the unit (Cb diacid) being selected from linear or branched aliphatic diacids, cycloaliphatic diacids and aromatic diacids;

X.T denotes a unit obtained from the polycondensation of a Cx diamine and terephthalic acid, with x representing the number of carbon atoms of the Cx diamine, x being between 5 and 36, advantageously between 9 and 18, especially a polyamide with formula A/5T, A/6T, A/9T, A/10T, or A/11T, A being as defined above, in particular a polyamide chosen from among a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, PA BACT/10T/6T, a PA 11/BACT/6T, PA 11/MPMDT/6T, PA 11/MPMDT/10T, PA 11/BACT/10T, a PA 11/MXDT/10T, an 11/5T/10T.

In particular, the semi-aromatic semi-crystalline polyamide is chosen from polyamide 11/5T or 11/6T or 11/10T, the MXDT/10T, the MPMDT/10T and the BACT/10T.

T corresponds to terephthalic acid, MXD corresponds to m-xylylene diamine, MPMD corresponds to methylpentamethylene diamine and BAC corresponds to bis(aminomethyl)cyclohexane. Said semi-aromatic polyam ides defined above especially have a Tg of greater than or equal to 80° C.

### Regarding the Structure

Said multilayer structure therefore comprises at least one sealing layer and at least one composite reinforcing layer, the innermost reinforcing layer being welded to the outermost sealing layer and that therefore adhere to each other.

All sealing layers present adhere to each other and all reinforcing layers present adhere to each other.

In one embodiment, the Tm, as measured according to ISO 11357-3: 2013, of the polyamide of said outermost adjacent sealing layer (1) differs from that of the polyamide of said innermost reinforcing layer (2) by at most 30° C.

In another embodiment, the Tg, as measured according to ISO 11357-2: 2013, of the polyamide of said outermost adjacent sealing layer (1) differs from that of the polyamide of said innermost reinforcing layer (2) by at most 30° C.

Advantageously, the Tm and the Tg of the polyamide of said outermost adjacent sealing layer (1) differ from that of the polyamide of said innermost reinforcing layer (2) by at most 30° C.

In one embodiment, each sealing layer comprises the same type of polyamide and each reinforcing layer comprises the same type of polyamide.

Said multilayer structure may comprise up to 10 sealing layers and up to 10 composite reinforcing layers of different natures.

It is obvious that said multilayer structure is not necessarily symmetrical and that it may therefore comprise more sealing layers than composite layers or vice versa, but there can be no alternating layers and reinforcing layers.

Advantageously, said multilayer structure comprises one, two, three, four, five, six, seven, eight, nine or ten sealing layers and one, two, three, four, five, six, seven, eight, nine or ten composite reinforcing layers.

Advantageously, said multilayer structure comprises one, two, three, four or five sealing layers and one, two, three, four or five composite reinforcing layers.

Advantageously, said multilayer structure comprises one, two or three sealing layers and one, two, or three composite reinforcing layers.

In one embodiment, said multilayer structure comprises a single sealing layer and several reinforcement layers, said reinforcement layer adjacent to the sealing layer being welded to said sealing layer and the other reinforcement layers being wound around the directly adjacent reinforcement layer.

In another embodiment, said multilayer structure comprises a single reinforcing layer and several sealing layers, said reinforcing layer being welded to said adjacent sealing layer.

In one advantageous embodiment, said multilayer structure comprises a single sealing layer and a single composite reinforcement layer, said reinforcement layer being welded to said sealing layer.

Advantageously, in said multilayer structure, each sealing layer consists of a composition comprising the same type of polyamide polymer P1i.

Advantageously, the polyamide P1i is identical for all the sealing layers.

Advantageously, said polymer P1i is a short-chain aliphatic polyamide, in particular chosen from a PA6, a PA610, a PA612 and a PA6/polyolefin mixture, or a long-chain, in particular chosen from a PA1010, PA1012, PA1212, PA11 and PA12, in particular PA 11 and PA12, or a semi-aromatic polyamide, in particular chosen from the polyamide 11/5T, 11/6T, 11/10T, MXDT/10T, MPMDT/10T and BACT/10T.

Advantageously, in said multilayer structure, each reinforcing layer consists of a composition comprising the same type of polyamide polymer P2j.

Advantageously, the polyamide P2j is identical for all the reinforcement layers.

Advantageously, said polymer P2j is a short-chain aliphatic polyamide, in particular chosen from a PA6, a PA610, a PA612, or long-chain, in particular chosen from a PA1010, PA1012, PA1212, PA11 and PA12, in particular PA 11 and PA12, or a semi-aromatic polyamide, in particular chosen from the polyamide 11/5T, 11/6T, 11/10T, MXDT/10T, MPMDT/10T and BACT/10T.

Advantageously, in said multilayer structure, each sealing layer consists of a composition comprising the same type of polyamide polymer P1i and each reinforcing layer consists of a composition comprising the same type of polyamide polymer P2j.

Advantageously, said polymer P1i is a short-chain aliphatic polyamide, in particular chosen from a PA6, a PA610, a PA612 and a PA6/polyolefin mixture, or a long-chain, in particular chosen from a PA1010, PA1012, PA1212, PA11 and PA12, in particular PA 11 and PA12, or a semi-aromatic polyamide, in particular chosen from the polyamide 11/5T, 11/6T, 11/10T, MXDT/10T, MPMDT/10T and BACT/10T and said polymer P2j is a short-chain aliphatic polyamide, in particular chosen from a PA6, a PA610, a PA612, or a long-chain, in particular chosen from a PA1010, PA1012, PA1212, PA11 and PA12, in particular PA11 and PA12, or a semi-polyamide aromatic, in particular chosen from the polyamide 11/5T, 11/6T, 11/10T, MXDT/10T, MPMDT/10T and BACT/10T.

In one embodiment, said multilayer structure consists of a single reinforcing layer and a single sealing layer in which said polymer P1i is a short-chain aliphatic polyamide, in particular chosen from a PA6, a PA610, a PA612 and a PA6/polyolefin, or long-chain mixture, in particular chosen from PA1010, PA1012, PA1212, PA11 and PA12, in particular PA 11 and PA12, or a semi-aromatic polyamide, in particular chosen from the polyamide 11/5T, 11/6T, 11/10T, MXDT/10T, MPMDT/10T and BACT/10T and said polymer P2j is a short-chain aliphatic polyamide, in particular chosen from a PA6, a PA610, a PA612, or a long-chain, in particular chosen from a PA1010, PA1012, PA1212, PA11 and PA12, in particular PA 11 and PA12, or a semi-aromatic polyamide, in particular chosen from polyamide 11/5T, 11/6T, 11/10T, MXDT/10T, MPMDT/10T and BACT/10T.

In one embodiment, said multilayer structure consists of a single reinforcing layer and a single sealing layer in which said polymer P1i is a short-chain aliphatic polyamide, in particular chosen from a PA6, a PA610, a PA612 and a PA6/polyolefin mixture, and said polymer P2j is a short-chain aliphatic polyamide, in particular chosen from a PA6, a PA610, a PA612.

In one embodiment, said multilayer structure consists of a single reinforcing layer and a single sealing layer in which said polymer P1i is a short-chain aliphatic polyamide, in particular chosen from a PA6, a PA610, a PA612 and a PA6/polyolefin mixture, and said polymer P2j is a long-chain aliphatic polyamide, in particular chosen from a PA1010, PA1012, PA1212, PA11 and PA12, in particular PA11 and PA12.

In one embodiment, said multilayer structure consists of a single reinforcing layer and a single sealing layer in which said polymer P1i is a short-chain aliphatic polyamide, in particular chosen from a PA6, a PA610, a PA612 and a PA6/polyolefin mixture, and said polymer P2j is a semi-aromatic polyamide, in particular chosen from the polyamide 11/5T, 11/6T, 11/10T, MXDT/10T, MPMDT/10T and BACT/10T.

In one embodiment, said multilayer structure consists of a single reinforcing layer and a single sealing layer in which said polymer P1i is a long-chain aliphatic polyamide, in particular chosen from a PA1010, PA1012, PA1212, PA11 and PA12, in particular PA11 and PA12, and said polymer P2j is a short-chain aliphatic polyamide, in particular chosen from a PA6, a PA610, a PA612.

In one embodiment, said multilayer structure consists of a single reinforcing layer and a single sealing layer in which said polymer P1i is a long-chain aliphatic polyamide, in particular chosen from a PA1010, PA1012, PA1212, PA11 and PA12, in particular PA11 and PA12, and said polymer P2j is a long-chain aliphatic polyamide, in particular chosen from a PA1010, PA1012, PA1212, PA11 and PA12, in particular PA11 and PA12.

In one embodiment, said multilayer structure consists of a single reinforcing layer and a single sealing layer in which said polymer P1i is a long-chain aliphatic polyamide, in particular chosen from a PA1010, PA1012, PA1212, PA11 and PA12, in particular PA11 and PA12, and said polymer P2j is a semi-aromatic polyamide, in particular chosen from the polyamide 11/5T, 11/6T, 11/10T, MXDT/10T, MPMDT/10T and BACT/10T.

In one embodiment, said multilayer structure consists of a single reinforcing layer and a single sealing layer in which said polymer P1i is a semi-aromatic polyamide, in particular chosen from the polyamide 11/5T, 11/6T, 11/10T, MXDT/10T, MPMDT/10T and BACT/10T and said polymer P2j is a short-chain aliphatic polyamide, in particular chosen from a PA6, a PA610, a PA612.

In one embodiment, said multilayer structure consists of a single reinforcing layer and a single sealing layer in which said polymer P1i is a semi-aromatic polyamide, in particular chosen from the polyamide 11/5T, 11/6T, 11/10T, MXDT/10T, MPMDT/10T and BACT/10T and said polymer P2j is a long-chain aliphatic polyamide, in particular chosen from a PA1010, PA1012, PA1212, PA11 and PA12, in particular PA11 and PA12.

In one embodiment, said multilayer structure consists of a single reinforcing layer and a single sealing layer in which said polymer P1i is a semi-aromatic polyamide, in particular chosen from the polyamide 11/5T, 11/6T, 11/10T, MXDT/10T, MPMDT/10T and BACT/10T and said polymer P2j is a semi-aromatic polyamide, in particular chosen from the polyamide 11/5T, 11/6T, 11/10T, MXDT/10T, MPMDT/10T and BACT/10T.

Advantageously, said multilayer structure further comprises at least one outer layer consisting of a fibrous material made of continuous glass fibers, which is impregnated with a transparent amorphous polymer, said layer being the outermost layer of said multilayer structure.

Said outer layer is a second reinforcement layer, but transparent, which makes it possible to be able to place text on the structure.

### Regarding the Fibrous Material

Regarding the fibers making up said fibrous material, they are in particular mineral, organic or plant fibers.

Advantageously, said fibrous material may be sized or unsized.

Said fibrous material can therefore comprise up to 3.5% by weight of an organic material (of thermoset or thermoplastic resin type), referred to as sizing.

The mineral fibers include carbon fibers, glass fibers, basalt or basalt-based fibers, silica fibers, or silicon carbide fibers, for example. The organic fibers include thermoplastic or thermosetting polymer-based fibers, such as semi-aromatic polyamide fibers, aramid fibers or polyolefin fibers, for example. Preferably, they are amorphous thermoplastic polymer-based and have a glass transition temperature Tg higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Advantageously, they are semi-crystalline thermoplastic polymer-based and have a melting temperature Tm higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Thus, there is no melting risk for the organic fibers constituting the fibrous material during the impregnation by the thermoplastic matrix of the final composite. The plant fibers include natural linen, hemp, lignin, bamboo, silk, in particular spider silk, sisal, and other cellulose fibers, in particular viscose. These plant fibers can be used pure, treated or coated with a coating layer, in order to facilitate the adherence and impregnation of the thermoplastic polymer matrix.

The fibrous material may also be a fabric, a braid or woven with fibers.

It may also correspond to fibers with support threads.

These component fibers may be used alone or in mixtures. Thus, organic fibers can be mixed with the mineral fibers to be pre-impregnated with thermoplastic polymer powder and to form the pre-impregnated fibrous material.

The organic fiber strands may have several grammages. They can further have several geometries. The component fibers of the fibrous material can further assume the form of a mixture of these reinforcing fibers with different geometries. The fibers are continuous fibers.

Preferably, the fibrous material is selected from glass fibers, carbon fibers, basalt fibers or basalt-based fibers, or a mixture thereof, in particular carbon fibers.

It is used in the form of one roving or several rovings.

According to another aspect, the present invention relates to a method of manufacturing a multilayer structure as defined above, characterized in that it comprises a step of filament winding of the reinforcing layer as defined above around the sealing layer as defined above.

All the characteristics detailed above also apply to the method.

### EXAMPLES

In all the examples, the tanks are obtained by rotational molding of the sealing layer (liner) at a temperature adapted to the nature of the thermoplastic resin used.

In the case of the composite reinforcement, a fibrous material previously impregnated with the thermoplastic resin (tape) is used. This tape is deposited by filament winding using a robot with a 1500 W laser heater at a speed of 12 m/min and there is no polymerization step.

### Example 1 (Counterexample)

Type IV hydrogen storage tank, composed of an epoxy composite reinforcement (Tg 100° C.) T700SC31E carbon fiber (produced by Toray) and a PA11 sealing layer.

### Example 2: Type IV Hydrogen Storage Tank, Composed of a T700SC31E Carbon Fiber PA11 Composite Reinforcement (Produced by Toray) and a PA11 Sealing Layer

The tanks thus obtained are subjected to cycled pressure tests, varying between 10 and 800 bar. Water is used to apply the pressure. The test is stopped after 10,000 cycles.

Following this, strips about 1 cm wide are cut from the tank. The adhesion between the liner and the composite is then measured, by initiating a detachment at the interface, and by carrying out a peel test using a traction machine. The peel strength is expressed in N/cm of strip width. In the case of example 1, the detachment is seen for a value of 3 N/cm. In the case of example 2, a force greater than 30 N/cm is reached.

1. A multilayer structure intended for transporting, distributing and storing hydrogen, in particular for storing hydrogen, comprising, from the inside to the outside, a sealing layer and at least one composite reinforcement layer,
an innermost composite reinforcing layer being welded to said outermost adjacent sealing layer,
said sealing layers consisting of a composition comprising:
at least one semi-crystalline polyamide thermoplastic polymer P1i, i=1 to n, where n is the number of sealing layers, excluding a polyether block amide (PEBA),
up to 50% by weight of impact modifier by weight of impact modifier relative to the total weight of the composition,
up to 1.5% by weight of plasticizer relative to the total weight of the composition,
said at least one polyamide thermoplastic polymer in each sealing layer may be the same or different,
and at least one of said composite reinforcement layers consisting of a fibrous material in the form of continuous fibers, which is impregnated with a composition predominantly comprising at least one semi-crystalline polyamide polymer P2j, j=1 to m, m being the number of reinforcement layers,
the number of carbon atoms per amide function of the polyamide of said outermost adjacent sealing layer differing from that of the polyamide of said innermost reinforcing layer by at most 20%.

2. The multilayer structure according to claim 1, wherein the Tm, as measured according to ISO 11357-3: 2013, of the polyamide of said outermost adjacent sealing layer differs from that of the polyamide of said innermost reinforcing layer by at most 30° C.

3. The multilayer structure according to claim 1, wherein the Tg, as measured according to ISO 11357-2: 2013, of the polyamide of said outermost adjacent sealing layer differs from that of the polyamide of said innermost reinforcing layer by at most 30° C.

4. The multilayer structure according to claim 2, wherein the Tm and the Tg of the polyamide of said outermost adjacent sealing layer differs from that of the polyamide of the said innermost reinforcing layer of at most 30° C.

5. The multilayer structure according to claim 1, wherein each sealing layer comprises the same type of polyamide.

6. The multilayer structure according to claim 1, wherein each reinforcing layer comprises the same type of polyamide

7. The multilayer structure according to claim 5, wherein each sealing layer comprises the same type of polyamide and each reinforcing layer comprises the same type of polyamide.

8. The multilayer structure according to claim 1, wherein it has a single sealing layer and a single reinforcing layer.

9. The multilayer structure according to claim 1, wherein said polymer P1i is a short-chain aliphatic polyamide having an average number of carbon atoms per nitrogen atom up to 9, or long-chained having an average number of carbon atoms per nitrogen atom greater than 9, or a semi-aromatic polyamide.

10. The multilayer structure according to claim 1, wherein said polymer P2j is a short-chain aliphatic polyamide having an average number of carbon atoms per nitrogen atom up to 9, or long-chained having an average number of carbon atoms per nitrogen atom greater than 9, or a semi-aromatic polyamide.

11. The multilayer structure according to claim 9, wherein said polymer P1i is a short-chain aliphatic polyamide having an average number of carbon atoms per nitrogen atom up to 9, or long-chained having an average number of carbon atoms per nitrogen atom greater than 9, or a semi-aromatic polyamide, and said polymer P2j is a short-chain aliphatic polyamide having an average number of carbon atoms per nitrogen atom up to 9, or long-chained having a number average number of carbon atoms per nitrogen atom greater than 9, or a semi-aromatic polyamide.

12. The multilayer structure according claim 1, wherein the fibrous material of the composite reinforcement layer is selected from glass fibers, carbon fibers, basalt fibers or basalt-based fibers, or a mixture thereof.

13. The multilayer structure according to claim 1, wherein said structure further comprises at least one outer layer consisting of a fibrous material made of continuous glass fibers, which is impregnated with a transparent amorphous polymer, said layer being the outermost layer of said multilayer structure.

14. A method for manufacturing a multilayer structure as defined in claim 1, wherein it comprises a step of welding the reinforcing layer onto the sealing layer.
